(19) United States
(12) Patent Application Publication
(10) Pub. No.: US 2007/0221466 A1
(43) Pub. Date: Sep. 27, 2007

(54) Clutch actuation method and apparatus

(76) Inventor: Daniel Levine, San Diego, CA (US)

Correspondence Address: PETER MARTINEZ, P.O. BOX 131313, CARLSBAD, CA, 92013, US

(21) Appl. No.: 11/388,534

(22) Filed: Mar. 24, 2006

(51) Int. Cl. F16D 25/08

(52) U.S. Cl. 192/85 CA

(57) ABSTRACT

A clutch actuation method and apparatus is provided. In one embodiment, a slave cylinder is mounted about a transmission input shaft, with a release bearing coupled to a first end of the slave cylinder, the release bearing having a release face structured to contact the release spring in the clutch pressure plate. A thrust bearing is coupled to a second end of the slave cylinder, the thrust bearing having a thrust face, and a thrust plate is coupled to the clutch housing, and sized to receive the thrust face on the thrust bearing. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to clutches. More particularly, the invention concerns a method and apparatus to actuate a vehicle clutch.

### BACKGROUND OF THE INVENTION

With regard to vehicles, a clutch is a device within a vehicles'drive train system that also includes the engine, transmission, and differential. The drive train components provide the vehicles' motive force, enabling the vehicle to transition from a stationary state to one of motion. One function performed by the drive train is to allow intermittent disengagement of the engine during the transmission's gear changes.

Engagement and subsequent disengagement of the engine from the transmission is made possible by the clutch. The most basic function of the clutch is to connect, and disconnect the engine from the remaining drive train. The term “clutch” refers to the friction disc, flywheel, throwout bearing, diaphragm spring and the pressure plate. The clutch enables the vehicle operator to start, stop, idle in neutral and shift gears. When a clutch is engaged it enables the remaining drive train components to operate at maximum efficiency. However, when the clutch “slips” engine power that should be transmitted to the driving wheels is lost in the form of heat caused by the slippage between the friction disk and the flywheel.

Generally, the amount of engine torque a clutch can transmit to the transmission is directly related to the load generated by the pressure plate that pushes the clutch's friction disk against the engine's flywheel. Engines that generate large amounts of torque require high-load pressure plates.

However, to disengage the clutch, the same load generated by the pressure plate must be overcome. A release mechanism, usually a concentric hydraulic slave cylinder, or a clutch fork contacting the throwout bearing push against the tips of the diaphragm spring located in the pressure plate. Pressure on the spring releases the pressure against the friction disk, disengaging the clutch. To exert the force against the spring, the concentric slave cylinder, or the clutch fork, are attached to the transmission case or a bell housing, which provides the support against which the slave, or clutch fork can push.

The force exerted by the concentric slave, or the clutch fork against the spring in the pressure plate is also transmitted to the engine's crankshaft, because the pressure plate is bolted to the flywheel, which is bolted to the crankshaft. High pressure-plate loads can place excessive force on the crankshaft thrust main bearings, wearing both the crankshaft and the bearing surfaces.

When the spring in the pressure plate is forced toward the engine, the clutch is known as a “push-type” and when the spring is pulled away from the engine, the clutch is known as a “pull-type.” That is, the throwout bearing on a push-type clutch pushes the diaphragm spring toward the engine, and with a pull-type, the throwout bearing pulls on the diaphragm spring. However, both systems exert the same total force on the crankshaft main bearings, either pushing against the crankshaft (push-type), or pulling on the crankshaft (pull-type).

For this reason, all crankshafts must employ a means to limit fore and aft movement within the block. This is accomplished with a crankshaft thrust main bearing. The crankshaft thrust main bearing is different from the other crankshaft main bearings because it employs lips that give the crankshaft thrust surfaces something against which to ride.

To address the thrust loads imparted by engagement and disengagement of the clutch, main bearing manufacturers design special crankshaft thrust main bearings. Some feature various grooves machined into the flange surface. The groove designs provide added lubrication for engines subject to high crankshaft main bearing thrust loads.

However, the flanged crankshaft thrust main bearings, and other crankshaft main bearing designs increase friction, thereby robbing horsepower from the engine. Also, engines constructed with these special crankshaft main bearing thrust designs are still prone to premature bearing failure due to the high thrust loads imparted by high thrust force pressure plates.

Therefore, there remains a need to overcome one or more of the limitations in the above-described, existing art.

### BRIEF DESCRIPTION OF THE DRAWINGS

FIG. 1 is a schematic view of clutch actuator constructed according to one embodiment of the present invention for use with a pull-type clutch;

FIG. 2 is a partial sectional view of the embodiment of FIG. 1, showing a sectional view of the pull-type clutch and an elevation view of the clutch actuator;

FIG. 3 is a sectional view of the clutch actuator shown in FIG. 2;

FIG. 4 is a partial sectional view of a pull-type clutch and an elevation view of a pull-type clutch actuator constructed according to another embodiment of the present invention;

FIG. 5 is a partial sectional view of a pull-type clutch and an elevation view of a pull-type clutch actuator constructed according to yet another embodiment of the present invention; and

FIG. 6 is a partial sectional view of a pull-type clutch and an elevation view of a pull-type clutch actuator constructed according to a final embodiment of the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Generally, the present invention eliminates any pressure, or thrust loads on the engine crankshaft during actuation of the clutch. Conventional “push-type” clutch actuation systems employ a concentric slave cylinder, or actuation fork that compresses the spring in the pressure plate. The concentric slave cylinder, or the support for the actuation fork is mounted to the transmission case or bell housing. The slave cylinder, or support for the actuation fork pushes against the transmission case or bell housing, enabling it to generate a compression force against the spring. The compression force is transmitted through the pressure plate and the flywheel to the crankshaft. Similarly, conventional “pull-type” clutch actuation systems also employ an actuation fork that pulls the spring away from the engine. The support for the actuation fork is similarly mounted to the transmission case or bell housing, resulting in the crankshaft experiencing a “pull” force.

One embodiment of the present invention tailored for use in a “push-type” clutch system eliminates the force acting upon the crankshaft by mounting a concentric hydraulic slave cylinder in a cage that is mounted directly to the pressure plate. Because the pressure plate itself provides the support for the slave cylinder, no thrust force is exerted on the crankshaft.

Another embodiment of the present invention tailored for use in a “pull-type” clutch system also eliminates the force acting upon the crankshaft. One embodiment employs a concentric slave cylinder having a bearing assembly mounted at each end of the slave cylinder. The slave cylinder expands, and pushes against the pressure plate and against a pull tube assembly, or splined tube (which are components used in “pull-type” clutches, discussed below) and thereby eliminates the generation of any external forces because, again, the pressure plate itself provides the support for the slave cylinder, thus eliminating any thrust forces on the crankshaft. Another embodiment of the present invention tailored for use in a “pull-type” clutch system employs a concentric slave cylinder having a bearing assembly mounted between the pull tube assembly and the diaphragm spring and a second bearing assembly mounted between the concentric slave cylinder and the pressure plate. This arrangement again uses the pressure plate to provide the support for the slave cylinder, thus eliminating any thrust forces on the crankshaft.

Put simply, for every action there is an equal and opposite reaction. In conventional clutch actuation systems, the clutch fork or concentric slave cylinder are mounted to the transmission case or bell housing, and push against these components when they push against the spring in the pressure plate. The present invention eliminates the transmission or bell housing mount, thereby also eliminating the generation of any external force that must be resisted by the crankshaft.

In the case of a “push-type” clutch system, the support is a cage that is mounted to the pressure plate. In the case of the “pull-type” clutch system, one end of a concentric slave cylinder “expands” away from the pressure plate, creating the pull force required to actuate the clutch, yet without generating a “pull” force on the crankshaft. In this embodiment, not only are pull forces on the crankshaft eliminated, but the clutch fork, and related components are also eliminated, as a concentric slave cylinder using two roller bearing assemblies is employed. This reduction in parts decreases manufacturing costs and maintenance costs, as well as system complexity.

Another advantage of any of the embodiments described herein is that smaller diameter friction disks, and their associated components (pressure plate and flywheel) can be employed. This is because one aspect of clutch design is a tradeoff between friction disk diameter and the clamp pressure, or load generated by the pressure plate. As the friction disk diameter decreases, the torque that it can transfer to the transmission input shaft also decreases. Conventional clutch manufacturers increase the pressure plate clamp pressure to compensate for the smaller diameter friction disks. However, high pressure plate clamp loads place excessive load on the crankshaft. Because the present invention eliminates crankshaft loads during clutch actuation, smaller diameter friction disks can be employed, decreasing manufacturing costs and increasing packaging options during drive train design.

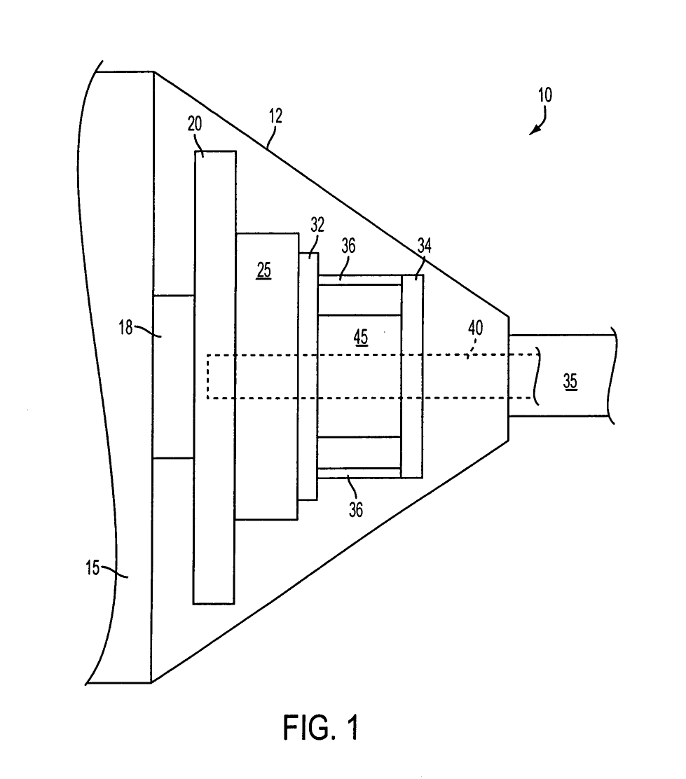

Referring now to FIG. 1, a schematic illustration of a push-type clutch actuation system constructed according to one embodiment of the present invention is shown. The clutch 25 is mounted to the engine flywheel 20, which is mounted to the end of the engine crankshaft 18 that is rotatably driven by the engine 15. The crankshaft 18, flywheel 20, and clutch 25 all rotate and transfer the rotation force (i.e., torque) to the transmission 35 via the transmission input shaft 40. Some vehicles employ a bell housing 12 that joins the engine 15 to the transmission 35. Other vehicles do not employ a bell housing 12, instead mounting the engine 15 directly to the transmission 35, which is sized to fit the illustrated components within it. It will be appreciated that the present invention may be employed within a bell housing 12, or within a transmission 35.

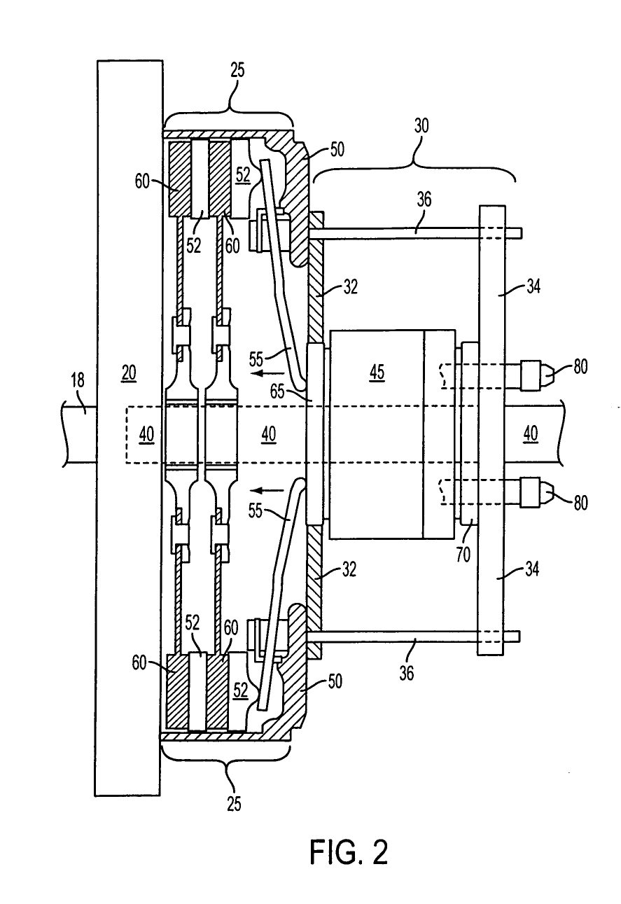

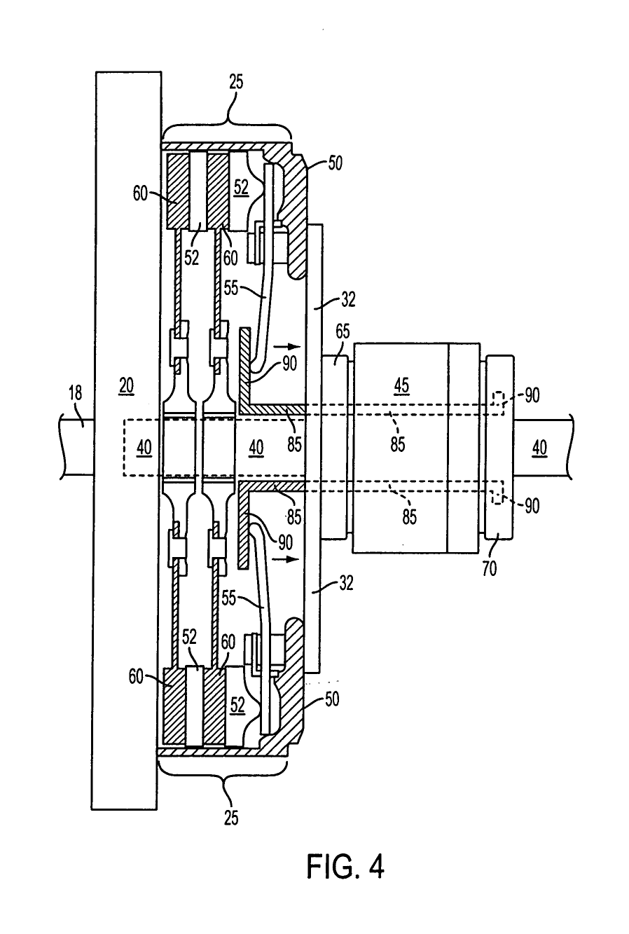

As shown in FIGS. 1 and 2, the clutch actuation system 10 comprises a clutch actuator 30 that includes a concentric slave assembly 45 with a throwout bearing 65 and a thrust bearing 70 located at opposite ends. A thrust plate 34 is fastened to a mount plate 32 by fasteners 36. Fasteners 36 may be rods, bolts, or any suitable component for attaching the thrust plate 34 to the mount plate 32, such as a cylindrical tube that connects the thrust plate to the mount plate 32. The mount plate 32 is fastened to the pressure plate 50 by suitable fasteners such as rivets, bolts, or other fastening means. As defined herein, pressure plate 50 also includes the housing that covers the pressure plate elements 50, such as the floater plates 52 (shown in FIGS. 2 and 4), and other associated pressure plate elements that are known in the art. It will be appreciated that alternative embodiments may not employ a mount plate 32, but instead fasten the thrust plate 34 directly to the pressure plate 50.

The clutch 25, shown in FIG. 2, includes the pressure plate 50 with a diaphragm spring, or spring fingers 55 attached thereto. The diaphragm spring 55 may be a Belville spring or individual spring finger elements, or their equivalents, as known in the art. The pressure plate 50 also includes one or more floater plates 52 that clamp one or more friction disks, or driven plates 60. FIGS. 2 and 4 illustrate two friction disks 60, but one or more that two friction disks 60 may be employed. The friction disks 60 have a splined center section that is sized to receive the corresponding splines on the transmission input shaft 40 (not shown). The construction of the pressure plate 50, diaphragm spring 55, friction disk(s) 60, and transmission input shaft and related components is well known in the art, and the present invention may be employed by any type of clutch construction.

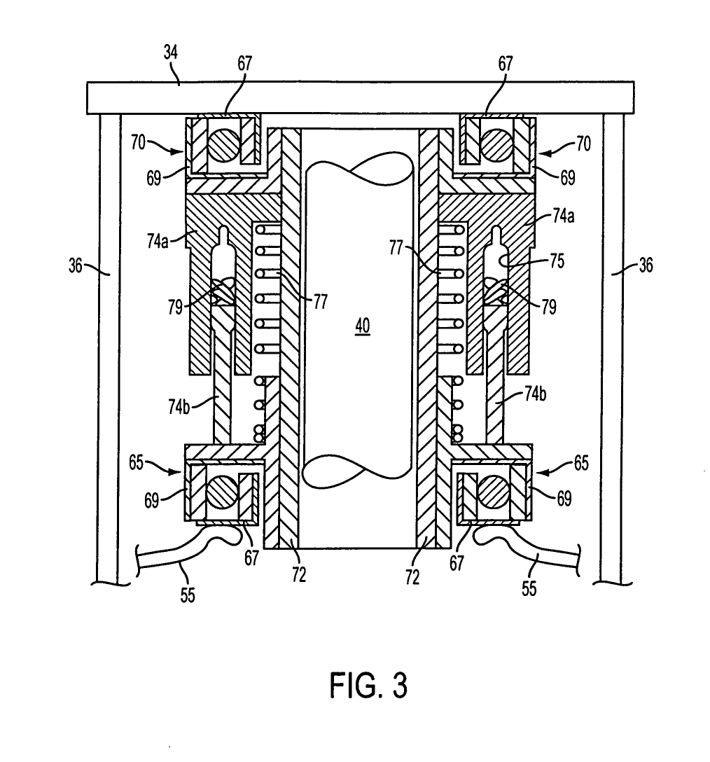

Referring now to FIG. 3, the components included in the concentric slave assembly 45, throwout bearing 65 and thrust bearing 70 are illustrated. The concentric slave assembly 45 has an annular transmission input shaft housing 72 that allows the transmission input shaft 40 to rotate freely within. Surrounding the annular transmission input shaft housing 72 are the annular walls 74a and 74b, with the annular wall 74a having a piston bore 75 that slideably receives the annular wall 74b. A bump stop 79 is positioned at the tip of annular wall 74b, and in conjunction with preload spring 77, keeps the annular wall 74b from “bottoming” within the piston bore 75. Hydraulic fluid (not shown) is pumped into, and out of, the piston bore 75 through fluid ports 80 (shown in FIG. 2) that may extend from the end (as shown) of the concentric slave assembly 45, or they may extend from the side (not shown) of the concentric slave assembly 45. As is known in the art, the fluid ports 80 are in fluid communication with a clutch master cylinder (not shown) that is actuated by the vehicle operator depressing a clutch pedal (not shown). Alternatively, the concentric slave may be operated by a hydraulic pump that is electronically controlled. Similar to the pressure plate 50, concentric slave assemblies, their operation and their internal construction are well known in the art, and the present invention may employ any type of concentric slave assembly, including types that may vary in construction from the one described and illustrated herein. However, in one embodiment, the present invention employs a concentric slave that includes a thrust bearing 70. This is in contrast to conventional concentric slave assemblies that only have a throwout bearing 65.

This is because a conventional clutch system that employs a conventional concentric slave mounts the concentric slave about the transmission input shaft, with one end of the slave attached to the front of the transmission, or to the bell housing, and the other end having a throwout bearing 65 in contact with the spring fingers 55. In operation, the pressure plate 50 5 rotates, along with the spring fingers 55 and the transmission input shaft 40. However, the slave assembly 45 does not rotate, as it is attached to the transmission or the bell housing. As shown in detail in FIG. 3, the throwout bearing 65 enables relative rotation between the slave assembly 45 and the spring fingers 55. The throwout bearing 65 comprises a release face, or thrust face 67 and a slave face 69 that are joined by a ball bearing cage having a plurality of ball bearings. When the release face 67 contacts the spring fingers 55 during clutch actuation, the release face 67 rotates with the spring fingers 55. However, the ball bearing cage allows the slave face 65 to remain substantially motionless, enabling the attachment of the slave assembly 45 to the transmission 35 or bell housing 12. The construction and operation of throwout bearings is well known in the art, and for example, in one embodiment of the present invention the throwout bearing 65 may be a high quality steel caged radius contact ball bearing. The throwout bearing 65 may have steel cages and hardened steel shells for durability and may be filled with grease that can withstand high temperatures. But, it will be appreciated that the present invention is not limited to a specific bearing construction, but instead may employ a throwout bearing 65 of virtually any construction.

Referring again to FIG. 3, one feature of the present invention not found on conventional concentric slave assemblies is the thrust bearing 70, mounted opposite the throwout bearing 65. As discussed above, conventional slave assemblies have the end opposite of the throwout bearing 65 attached directly to the transmission or the bell housing. As these components do not rotate, a bearing assembly is not required. But, as discussed above, the conventional slave assembly thrusts against the transmission or bell housing when actuating the spring fingers, thereby transmitting that thrust force ultimately to the crankshaft.

The present invention eliminates the generation of thrust forces against the crankshaft by eliminating the connection between the slave assembly and the transmission or bell housing. As shown in FIG. 2, the end of the slave assembly 45 opposite the throwout bearing 65 is mounted to thrust plate 34, which is attached to the pressure plate 50 by fasteners 36. Because the pressure plate 50 rotates, the mount plate 32, fasteners 36, and thrust plate 34 also rotate. To keep the main body of the slave assembly 45 relatively stationary, a thrust bearing 70 is positioned between the thrust plate 34 and the end of the slave assembly 45 proximate to the thrust plate 34. One embodiment of the present invention contemplates a slave assembly 45 with the throwout bearing 65 and thrust bearing 70 constructed integral to the slave assembly 45. However, it will also be appreciated that a non-integral thrust bearing 70 may also be employed.

As shown in detail in FIG. 3, in one embodiment of the present invention, the thrust bearing 70 is constructed substantially identically to the throwout bearing 65. Specifically, the release face, or thrust face 67 is in contact with the thrust plate 34, and the slave face 69 is attached to the annular wall 74a of the slave assembly 45. Between the release face 67 and the slave face 69 is a ball bearing cage having a plurality of ball bearings. As discussed above in connection with the throwout bearing 65, the thrust bearing 70 may be a high quality steel caged radius contact ball bearing. The thrust bearing 70 may have steel cages and hardened steel shells for durability and may be filled with grease that can withstand high temperatures. But, it will be appreciated that the present invention is not limited to a specific bearing construction, but instead may employ a thrust bearing 70 of virtually any construction.

Referring again to FIG. 2, the main body of the slave assembly 45, comprising the annular walls 74a and 74b, can now remain substantially motionless, while the thrust plate 34, fasteners 36, and mount plate 32 all rotate with the pressure plate 50. The fluid ports 80 also remain substantially motionless as they communicate with one of the annular walls 74a or 74b, depending on the specific construction of the slave assembly 45. For example, in one embodiment, the fluid ports 80 exit as shown in FIG. 2, adjacent to the transmission input shaft 40. In another embodiment, the fluid ports 80 may exit out the side of one of the annular walls 74a or 74b. The present invention contemplates different arrangements for the fluid ports 80, as required for each type of transmission or bell housing.

Referring now to FIGS. 2 and 3, the operation of the clutch actuator system 10 will now be described. When the transmission input shaft 40 is engaged with the crankshaft 18, the flywheel 20, pressure plate 50, mount plate 32, fasteners 36 and thrust plate 34 are all rotating at the same rate, or revolutional speed. When the vehicle operator wishes to disengage the transmission 35 from the engine 15, hydraulic fluid is pumped into one fluid port 80, and the annular walls 74a and 74b are forced apart by the hydraulic fluid. Annular wall 74a pushes thrust bearing 70 against thrust plate 34, while annular wall 74b pushes throwout bearing 65 against spring fingers 55. However, the slave faces 69 of the throwout bearing 65 and thrust bearing 70, which are connected to the annular walls 74b, and 74a, respectively, do not rotate, enabling the annular walls 74a and 74b to remain substantially rotation-free. As the piston bore 75 fills with hydraulic fluid and pushes the annular walls 74a and 74b away from each other, the spring fingers are pushed toward the flywheel 20 (shown by arrows in FIG. 2) causing the floater plates 52 to release the friction disk, or disks 60. The friction disks 60, which are connected via a splined center section to the splines (not shown) on the transmission input shaft 40, are now allowed to cease rotation, or rotate at a revolution different than the engine's crankshaft 18. In this manner, a different gear may be selected in the transmission 35, or the vehicle may become stationary, while the crankshaft 18 continues to rotate.

However, because the slave assembly 45 pushes against the thrust plate 34 to generate the force used to depress the spring fingers 55, and the thrust plate 34 is attached to the pressure plate 50, the crankshaft 18 does not experience any thrust forces. Put differently, by eliminating the transmission mount or bell housing mount for the slave assembly, the external thrust force is also eliminated. Thus, the extreme clutch pressure-plate loads on manual-transmission vehicles that place excessive pressure on the crankshaft thrust bearing, wearing both the crankshaft and the bearing surfaces, is eliminated. It will be appreciated that the above discussion is related to “manual” transmission vehicles, where the vehicle operator actuates the clutch by depressing a clutch pedal. However, the present invention may also be employed by electronically controlled drive trains, where for example, the vehicle operator selects a specific gear in the transmission by pushing a button or moving a gear shift lever, or “paddle.” The electronically controlled transmission then actuates the concentric slave assembly by using an electronically controlled hydraulic pump, thus eliminating the need for use of the clutch pedal (which may be retained for activation of the drive train in a “manual mode,” where electronic control is reduced).

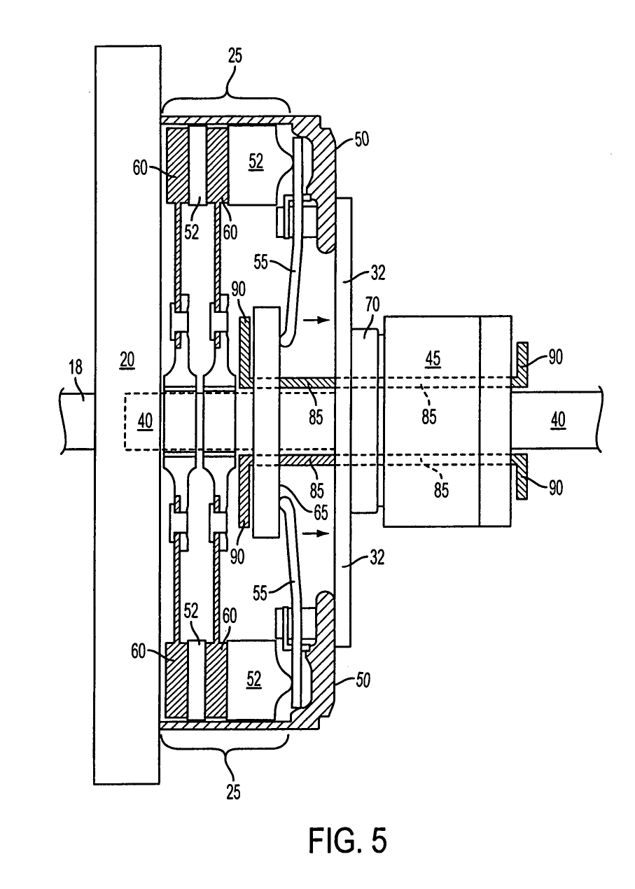

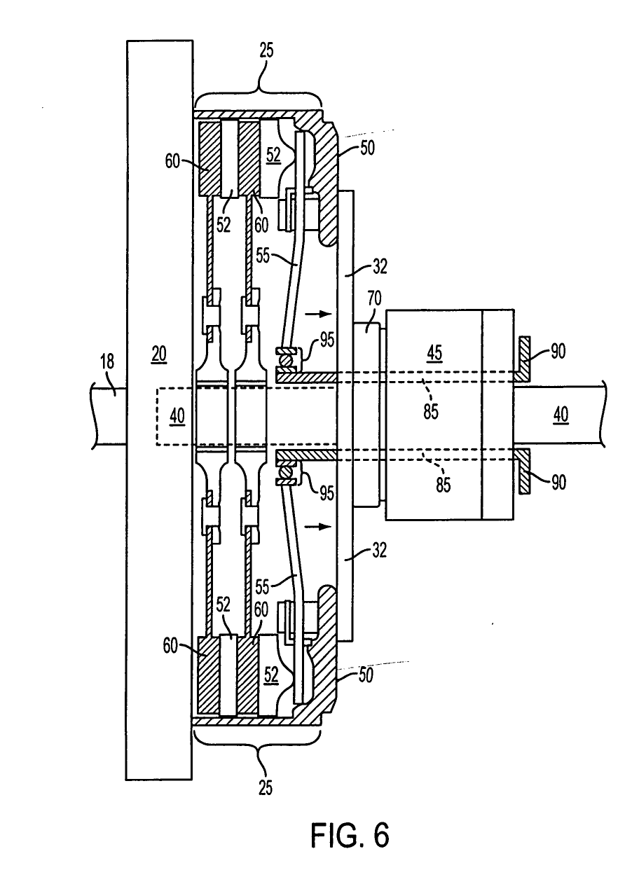

The above discussion in connection with FIGS. 1-3 relates to “push-type” clutches, as the spring fingers 55 are “pushed” toward the engine 15. Other embodiments of the present invention, designed for use with “pull-type” clutches are illustrated in FIGS. 4-6. As shown in FIGS. 4-6, a “pull-type” clutch pulls the spring fingers 55 away from the engine's crankshaft 18. Specifically, the diaphragm spring, or spring fingers 55, which may be a Belville spring, or individual spring fingers, or any equivalents, are generally positioned so that the tips of the spring fingers 55 are pointed toward the flywheel 20. In contrast, the tips of the spring fingers 55 on a “pull-type” clutch, shown in FIG. 2, generally point away from the flywheel 20. In the embodiment illustrated in FIG. 4, a pull-tube assembly 85, including pull-tube hardware 90 is positioned between the spring fingers 55 and the friction disk, or disks 60. In the embodiment illustrated in FIG. 5, a pull-tube assembly 85, including pull-tube hardware 90 is positioned behind the throwout bearing 65, which contacts the spring fingers 55. In the embodiment illustrated in FIG. 6, a pull-tube assembly 85, including pull-tube hardware 90 is positioned adjacent to the tips of the spring fingers 55.

Referring to FIG. 4, one embodiment of the present invention for use with a “pull-type” clutch is illustrated. A mount plate 32 is attached to the pressure plate 50, or to a “hat” located over the pressure plate 50. This is because some pull-type clutches found on semi-tractors may include a “hat” or cover that fits over the pressure plate 50. The present invention may also be employed by these types of pull-type clutches, as well as pull-type clutches that may be found on other types of trucks, vans, passenger automobiles, off-road vehicles (such as farm machinery, and earth-moving equipment) and any other vehicle that may employ a pull-type clutch. In a preferred embodiment, the pressure plate 50, or “hat” may be constructed to receive the slave assembly 45, thereby eliminating the mount plate 32. As described above in connection with a “pull-type” clutch, throwout bearing 65 is positioned adjacent to the mount plate, with a thrust bearing 70 located opposite the throwout bearing 65. In this embodiment, the release face 67 of the throwout bearing 65 contacts the mount plate 32, with the slave face 69 attached to the annular wall 74b, as shown in FIG. 3. Similarly, the slave face 69 on the thrust bearing 70 is attached to the annular wall 74a, as also shown in FIG. 3, but the release face 67 now engages the pull tube hardware 90 that is attached to the pull-tube 85. In this embodiment, the thrust plate 34, and fasteners 36 are eliminated.

In operation, the slave assembly 45 expands, pulling the pull tube 85 and the pull-tube hardware 90 away from the flywheel 20, thereby also pulling the spring fingers 55 away from the flywheel 20. Specifically, and similar to the embodiment illustrated in FIGS. 2 and 3, when the vehicle operator wishes to disengage the transmission 35 from the engine 15, hydraulic fluid is pumped into one fluid port 80 (not shown in FIG. 4), and the annular walls 74a and 74b are forced apart by the hydraulic fluid. Annular wall 74a pushes the release face 67 of the thrust bearing 70 against the pull tube hardware 90 (which at this location may be a flange, or ring), while the annular wall 74b pushes the release face 67 of the throwout bearing 65 against the mount plate 32. However, the slave faces 69 of the throwout bearing 65 and thrust bearing 70, which are connected to the annular walls 74b, and 74a, respectively, do not rotate, enabling the annular walls 74a and 74b to remain substantially rotation-free. As the piston bore 75 fills with hydraulic fluid and pushes the annular walls 74a and 74b away from each other, the pull tube 85, which is connected to the pull-tube hardware 90 (which in this embodiment may be a flange, ring, disk or other component) pulls the spring fingers 55 away from the flywheel 20 (shown by arrows in FIG. 4). This causes the floater plates 52 to release the friction disk, or disks 60. The friction disks 60, which are connected via a splined center section to the splines (not shown) on the transmission input shaft 40, are now allowed to cease rotation, or rotate at a revolution 5 different than the engine's crankshaft 18. In this manner, a different gear may be selected in the transmission 35, or the vehicle may become stationary, while the crankshaft 18 continues to rotate.

Referring now to FIG. 5, the pull-tube hardware 90, as well as the pull-tube 85 do not rotate, as they are insulated from the rotating spring fingers 55 by the throwout bearing 65. In this embodiment, the throwout bearing 65 is positioned between the diaphragm spring, or spring fingers 55 and the pull-tube hardware 90. Now, the release face 67 (not shown) of the throwout bearing 65 contacts the pull-tube hardware 90, and the slave face 69 (not shown) of the throwout bearing 65 contacts the spring fingers 55. The thrust bearing 70 is now positioned between the slave assembly 45 and the mount plate 32. The mount plate 32 rotates, but the release face 67 (not shown) of the thrust bearing 70 contacts the mount plate 32, and the slave face 69 (not shown) of the thrust bearing 70 is attached to the annular wall 74b of the slave assembly 45. The pull-tube hardware 90 (in this embodiment, a flange, ring, disk or other component) rests against the top of the slave assembly 45, and neither the slave assembly 45 or the pull-tube 85 or pull-tube hardware 90 rotate. As the piston bore 75 (shown in FIG. 3) in the slave assembly 45 fills with hydraulic fluid and pushes the annular walls 74a and 74b away from each other, the pull-tube hardware 90 at the top, or adjacent to the top of the slave assembly 45 expands away from the clutch 25, thereby pulling the pull-tube hardware 90 located adjacent to the throwout bearing 65 against the spring fingers 55, which move away from the flywheel 20 (shown by arrows in FIG. 5). This causes the floater plates 52 to release the friction disk, or disks 60, which are connected via a splined center section to the splines (not shown) on the transmission input shaft 40. The transmission input shaft 40 is now allowed to cease rotation, or rotate at a revolution different than the engine's crankshaft 18. In this manner, a different gear may be selected in the transmission 35, or the vehicle may become stationary, while the crankshaft 18 continues to rotate.

The embodiment illustrated in FIG. 6 functions similarly to that illustrated in FIG. 5, in that the pull-tube hardware 60 and pull-tube assembly 85 do not rotate, but in this embodiment, a spring finger bearing assembly 95 is employed. In this embodiment, the spring finger bearing assembly 95 is positioned between the diaphragm spring tips, or spring finger 55 tips and the pull-tube hardware 90. That is, the spring finger bearing assembly 95 is oriented so that an outer bearing surface contacts the ends of the spring fingers 55, and an inner bearing surface contacts the pull-tube 85 allowing relative rotation between the two (thus the rotational axis of this bearing is rotated 90 degrees from the rotational axis of the thrust bearing 70). Because the diameter defined by the spring fingers 55 changes as they move, the outer bearing surface contacting the spring fingers 55 is allowed to “float.” This may be accomplished a number of different ways, such as having a bearing surface with two lips or flanges that slideably capture the spring fingers 55 between them.

Now, the bearing face contacting the spring fingers 55 rotates, but the bearing face contacting the pull-tube 85 does not rotate. Similar to FIG. 5, the thrust bearing 70 is now positioned between the slave assembly 45 and the mount plate 32. The mount plate 32 rotates, but the release face 67 (not shown) of the thrust bearing 70 contacts the mount plate 32, and the slave face 69 (not shown) of the thrust bearing 70 is attached to the annular wall 74b of the slave assembly 45. The pull-tube hardware 90 (in this embodiment, a flange, ring, disk or other component) rests against the top, or adjacent to the top of the slave assembly 45, and neither the slave assembly 45 or the pull-tube 85 or pull-tube hardware 90 rotate. As the piston bore 75 (shown in FIG. 3) in the slave assembly 45 fills with hydraulic fluid and pushes the annular walls 74a and 74b away from each other, the pull-tube hardware 90 at the top of the slave assembly 45 expands away from the clutch 25, thereby pulling the pull-tube hardware 90 and the spring finger bearing assembly 95 against the spring fingers 55, which move away from the flywheel 20 (shown by arrows in FIG. 6). This causes the floater plates 52 to release the friction disk, or disks 60, which are connected via a splined center section to the splines (not shown) on the transmission input shaft 40. The transmission input shaft 40 is now allowed to cease rotation, or rotate at a revolution different than the engine's crankshaft 18. In this manner, a different gear may be selected in the transmission 35, or the vehicle may become stationary, while the crankshaft 18 continues to rotate.

The embodiments discussed above, and illustrated in FIGS. 4-6, of the present invention eliminates the clutch fork, clutch fork mount, and related components used to actuate the clutch fork found on semi-tractors and other trucks, and passenger automobiles. A substantial cost, and weight savings is realized, along with a decrease in maintenance costs.

In the embodiments illustrated in FIGS. 4-6, the pull-tube hardware 90 may be flanges, rings, clips, disks and other components that are well known in the art. For example, the pull-tube 85 may comprise a splined, or un-splined tube that may be integrally constructed with the pull tube hardware 90. Alternatively, the pull-tube hardware 90 may be separate from the pull-tube 85, and during construction, the pull-tube hardware 90 may be attached to the pull-tube 85. For example, as is well known in the art, the pull-tube 85 may be a splined tube, or other arrangement, which is attached to the pull-tube hardware 90 by use of a snap-ring seated in a slot (not shown), within the pull tube 85. The embodiments illustrated in FIGS. 4-6 may use any type of pull-tube hardware 90, and pull-tube 85, regardless of its specific configuration, as pull-tube hardware 90, and pull-tubes 85 are well known in the art.

Similarly, many different pull-type pressure plate 50 and clutch 25 arrangements exist. For example, a pull-type pressure plate 50 and clutch 25 arrangement for a semi-tractor may vary significantly from one used for passenger vehicles. The present invention is not limited to the pull-type pressure plate 50 and clutch 25 arrangement illustrated in the Figures, but may be employed by any type of pull-type pressure plate 50 and clutch 25 arrangement.

For the purposes of interpreting words used in the claims, it is to be noticed that the term “comprising”, should not be interpreted as being limitative to the claim elements listed thereafter. Thus, the scope of the expression “a device comprising elements A and B” should not be limited to devices consisting only of components A and B. It means that with respect to the present invention, the only relevant components of the device are A and B.

Similarly, it is to be noticed that the term “coupled”, also used in the claims, should not be interpreted as meaning attached or joined together, but not limitative to direct connections only. Thus, the scope of the expression “an element A coupled to an element B” should not be limited to devices or systems wherein element A is directly connected to element B. It means that there exists a path between A and B which may be a path including other elements or means. In addition, when element A is “coupled” to element B, relative motion may be allowed between element A and element B.

Thus, it is seen that a clutch actuation method and apparatus is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A clutch actuator for use with a clutch comprising a release spring and housing sized to fit about a transmission input shaft, the clutch actuator comprising:
a slave cylinder structured to be mounted concentrically about the transmission input shaft, the slave cylinder having a first end and a second end;
a thrust plate structured to be coupled to the clutch housing, and sized to receive the slave cylinder;
a release bearing structured to be positioned between the first end of the slave cylinder and the release spring, the release bearing having a release face structured to contact the release spring; and
a thrust bearing structured to be positioned between the second end of the slave cylinder, the thrust bearing having a thrust face structured to contact the thrust plate.

2. The clutch actuator of claim 1, wherein when the slave cylinder is actuated, the thrust face contacts the thrust plate, thereby resisting a thrust force created by the slave cylinder when the release face depresses the release spring.

3. The clutch actuator of claim 1, further comprising a mount plate coupled to the housing, the mount plate sized to receive the slave cylinder, the mount plate including at least one support that couples the thrust plate to the mount plate.

4. The clutch actuator of claim 1, wherein the housing comprises a pressure plate having the release spring mounted therein, and including at least one friction disk concentrically mounted about the transmission input shaft.

5. The clutch actuator of claim 1, wherein the slave cylinder comprises two annular walls in slideable engagement with each other.

6. A method of actuating a clutch sized to fit about a transmission input shaft, the method comprising the steps of:
providing a clutch housing including a release spring, both mounted about the transmission input shaft;
mounting a slave cylinder to the clutch housing and about the transmission input shaft;
actuating the slave cylinder to actuate the release spring, thereby creating a release force; and
opposing the release force through the slave cylinder mounting to the clutch housing.

7. The method of claim 6, wherein the step of opposing the release force through the slave cylinder mounting to the clutch housing is accomplished by the steps of:
coupling a mount plate to the clutch housing, the mount plate sized to receive a release bearing that is coupled to the slave cylinder; and
coupling a thrust plate to the mount plate, the thrust plate sized to receive a thrust bearing coupled to an end of the slave cylinder opposite the release bearing.

8. The method of claim 6, wherein the step of actuating the slave cylinder to actuate the release spring, comprises the step of:
introducing a hydraulic fluid into a piston bore located in at least one of two annular walls in slideable engagement with each other, the annular walls forming a portion of the slave cylinder.

9. The method of claim 6, wherein the clutch housing comprises a pressure plate having the release spring mounted therein, and including at least one friction disk concentrically mounted about the transmission input shaft.

10. The method of claim 6, wherein the release spring is selected from a group consisting of: a Belville spring, and a plurality of individual spring finger elements.

11. The method of claim 6, wherein the step of opposing the release force through the slave cylinder mounting to the clutch housing is accomplished by the steps of:
coupling a first face of a spring bearing to the release spring, and coupling a second face of the spring bearing to a pull tube, the pull tube coupled adjacent to a first end of the slave cylinder; and
coupling a thrust bearing to a second end of the slave cylinder, the thrust bearing providing the slave cylinder mounting to the clutch housing.

12. A clutch actuator for use with a clutch comprising a housing including a release spring having a pull tube slideably coupled thereto, the pull tube sized to fit concentrically about a transmission input shaft, the clutch actuator comprising:
a slave cylinder structured to be mounted concentrically about the transmission input shaft and the pull tube;
a release bearing positioned between the slave cylinder and the housing; and
a thrust bearing coupled to a distal end of the slave cylinder, and sized to receive a distal end of the pull tube.

13. The clutch actuator of claim 12, wherein when the slave cylinder is actuated, the thrust bearing contacts the distal end of the pull tube, thereby forcing the pull tube against the release spring, pulling the release spring toward the slave cylinder.

14. The clutch actuator of claim 12, further comprising a mount plate coupled to the housing, the mount plate sized to receive the release bearing.

15. A method of actuating a clutch sized to fit about a pull tube that fits about a transmission input shaft, the pull tube also positioned adjacent to a release spring, the method comprising the steps of:
providing a clutch housing that includes the release spring and the pull tube;
mounting a slave cylinder to the clutch housing and about the pull tube and the transmission input shaft; and
actuating the slave cylinder to move the pull tube away from the clutch housing, thereby actuating the release spring.

16. The method of claim 15, wherein the step of actuating the slave cylinder to move the pull tube away from the clutch housing, comprises the step of:
introducing a hydraulic fluid into a piston bore located in at least one of two annular walls in slideable engagement with each other, the annular walls forming a portion of the slave cylinder, the annular walls moving apart from each other when the hydraulic fluid is introduced.

17. A clutch actuator for use with a clutch comprising a housing including a release spring and a pull tube, the pull tube sized to fit concentrically about a transmission input shaft and having a proximate end and a distal end, the clutch actuator comprising:
a slave cylinder structured to be mounted concentrically about the transmission input shaft and the pull tube;
a thrust bearing positioned between the housing and the slave cylinder; and
a release bearing positioned between the release spring and the proximate end of the pull tube.

18. The clutch actuator of claim 17, wherein when the slave cylinder is actuated, the slave cylinder contacts the distal end of the pull tube, thereby forcing the proximate end of the pull tube against the release bearing, which pulls the release spring toward the slave cylinder.

19. The clutch actuator of claim 17, further comprising a mount plate coupled to the housing, the mount plate sized to receive the thrust bearing.

20. A clutch actuator for use with a clutch comprising a housing including a pull tube and a release spring comprising a plurality of spring tips, with the pull tube sized to fit concentrically about a transmission input shaft and having a proximate end and a distal end, the clutch actuator comprising:
a slave cylinder structured to be mounted concentrically about the transmission input shaft and the pull tube;
a thrust bearing positioned between the housing and the slave cylinder; and
a release bearing having a bearing spring face slideably coupled to the plurality of spring tips, and a pull face coupled to the proximate end of the pull tube.

21. The clutch actuator of claim 20, wherein when the slave cylinder is actuated, the slave cylinder contacts the distal end of the pull tube, thereby pulling the proximate end of the pull tube, which pulls the release bearing and the plurality of release spring tips toward the slave cylinder.

22. The clutch actuator of claim 20, further comprising a mount plate coupled to the housing, the mount plate sized to receive the thrust bearing.
